(19) United States
(12) Patent Application Publication
(10) Pub. No.: US 2002/0111947 A1
(43) Pub. Date: Aug. 15, 2002

(54) Transmission controls on e-mails

(76) Inventor: Christopher I. Dalton, Bristol (GB)

Correspondence Address: HEWLETT-PACKARD COMPANY, Intellectual Property Administration, P.O. Box 272400, Fort Collins, CO, 80527-2400, US

(21) Appl. No.: 10/075,417

(22) Filed: Feb. 14, 2002

(30) Foreign Application Priority Data
Feb. 15, 2001 (GB) 0103736.5

(51) Int. Cl. G06F 7/00

(52) U.S. Cl. 707/10

(57) ABSTRACT

The invention provides a method of communicating an e-mail text message, over a network from a user terminal (PC1, MOB) to an intended recipient terminal (PC2) at a remote location, the method comprising the steps of:

(a) the user terminal (PC1, MOB) specifying a confidential message store address of a server WS1 that is capable of being accessed by the recipient computer via the network;

(b) the user computer transmitting the text message to the store address to reside therein; and

(c) the user terminal (PC1, MOB) transmitting a notification over the network to the recipient, the notification incorporating the selected store address and an instruction to the intended recipient to communicate with the store address.

The recipient terminal on opening up the e-mail accesses the store address to retrieve the e-mail.

This invention relates to method and apparatus for applying transmission controls to e-mails, over a network providing access to a very large number of users, primarily publicly usable networks such as the internet, but also an intranet.

### BACKGROUND TO THE INVENTION

With current e-mail transmission systems once an instruction to send an e-mail to a specified recipient address has been given it is generally not possible to prevent the e-mail being received by that address if the sender has second thoughts as to what should have been sent and to whom. This is particularly annoying when the sender knows that the intended recipient probably has not yet viewed the content of the e-mail.

Quite often the circumstances which led to the sending of the e-mail can change shortly after the e-mail was sent, and the sender of the e-mail would like the opportunity to revise or even withdraw the message sent.

In sending e-mails via the internet, because of the extremely large number of users and consequently e-mail addresses, any mistake in an e-mail address will probably result in the e-mail being received by someone who happens to have the address that was wrongly given. This can sometimes have serious consequences because important confidential information may be released to an unscrupulous recipient who may then seek to make use of that information for profit.

### SUMMARY OF THE INVENTION

In brief, we have appreciated that with advantage an e-mail system can send references to locations, for example URLs, Uniform Resource Locators, rather than sending the message itself, and the message content can be automatically placed into a message store, e.g. a web server, on the sender side. The reference notification sent to the desired recipient/s points to this location. Since the actual message content still resides with the sender, the sender can have a degree of control over that information even after the message has been sent.

According to one aspect of the invention we provide a method of communicating an e-mail text message over a network from a user terminal to an intended recipient terminal at a remote location, characterised by the steps of:

(a) the user terminal specifying a confidential message store address of a server that is capable of being accessed by the recipient computer via the network;

(b) the user terminal transmitting said e-mail text message to said store address to reside therein;

(c) the user terminal transmitting a notification over the network to the recipient, said notification incorporating said selected store address and an instruction to the intended recipient to communicate with said store address; and

(d) said recipient terminal accessing said store address to retrieve said text message.

The message store address may be a pre-allocated address or it may be an address that is selected from a range of possible addresses.

It can sometimes be more important urgently to notify an intended recipient of an e-mail than the actual content of the e-mail itself. There can, therefore, be occasions on which it is preferred that step (c) is performed prior to step (b), and the user's terminal is preferably configured to provide for this option. Thus, the reference to location may on occasion be transmitted to the recipient even before the e-mail message has been composed.

Although the user terminal might be a mobile telephone, preferably the user terminal is a PC, personal computer (comprising CPU, ROM, RAM, input/output and non-volatile memory).

The connection between the personal computer and the internet can be through a modem and telephone line via a private network service provider that is directly connected to the internet, through an ISP, internet service provider, who is directly connected to the internet, or via a direct high-speed data connection.

The server is preferably incorporated into the PC. This has the advantage, over use of a remote server, of the PC more easily monitoring access of the store address, and implementing any authentication controls which may be considered desirable over the accessing of the data from the store address.

The arrangement may permit unlimited accessing of the store address, but preferably only a predetermined number of access events is permitted which may be one only.

It may, for example, be desired that only a small number of people, from a larger pool of people to whom the notification of an available e-mail has been sent, are required to read a message before the message is to be deleted from the store address, for example the limited number of people to be given free tickets to an event.

The method may comprise an authentication step which must be successfully completed prior to the recipient terminal being permitted to access the store address, said authentication step comprising an authentication communication between the recipient terminal and the server, the server determining from the identity proffered by the user terminal whether or not to allow access to the data.

According to a second aspect of the invention we provide a computer terminal capable of transmitting data over a network to a remote recipient computer, characterised in that the computer terminal is configured such that on inputting of an instruction to cause an e-mail text message to be transmitted to a recipient computer, the transmitting terminal instead selects a confidential message store address on a server that is capable of being accessed via the network by the recipient computer, the transmitting terminal transmits the text message to that store address, and sends a notification via the network to the recipient computer, the notification providing information that the text message is available to the recipient computer by accessing the particular store address.

In order to provide the sender with some time to review and possibly change an e-mail message that has been ‘sent’, the computer terminal may comprise a delay timer for delaying the transfer of data from the computer terminal to the message store address until a predetermined time has elapsed after the terminal attempted to issue the alert message to the recipient computer.

The e-mail text message may have an attachment associated therewith.

According to a third aspect of the invention we provide a computer readable program code executable by a user terminal to cause the following steps to be executed by said user terminal in response to a user command to said user terminal to transmit an e-mail text message from said user terminal to a recipient terminal, said steps comprising:

(a) the user terminal specifying a confidential message store address of a server that is capable of being accessed by the recipient computer via the network;

(b) the user terminal transmitting said e-mail text message to said store address to reside therein; and

(c) the user terminal transmitting a notification over the network to the recipient, said notification incorporating said selected store address and an instruction to the intended recipient to communicate with said store address.

### BRIEF DESCRIPTION OF THE DRAWINGS

Some embodiments of the invention will now be described, by way of example only, with references to the accompanying drawings in which:

FIG.1 is a schematic flow diagram showing an e-mail communication procedure in accordance with the invention,

FIG. 2 is a schematic of the nodes involved in the communication procedure of FIG. 1,

FIG. 3 is a schematic of a modification to the schematic of

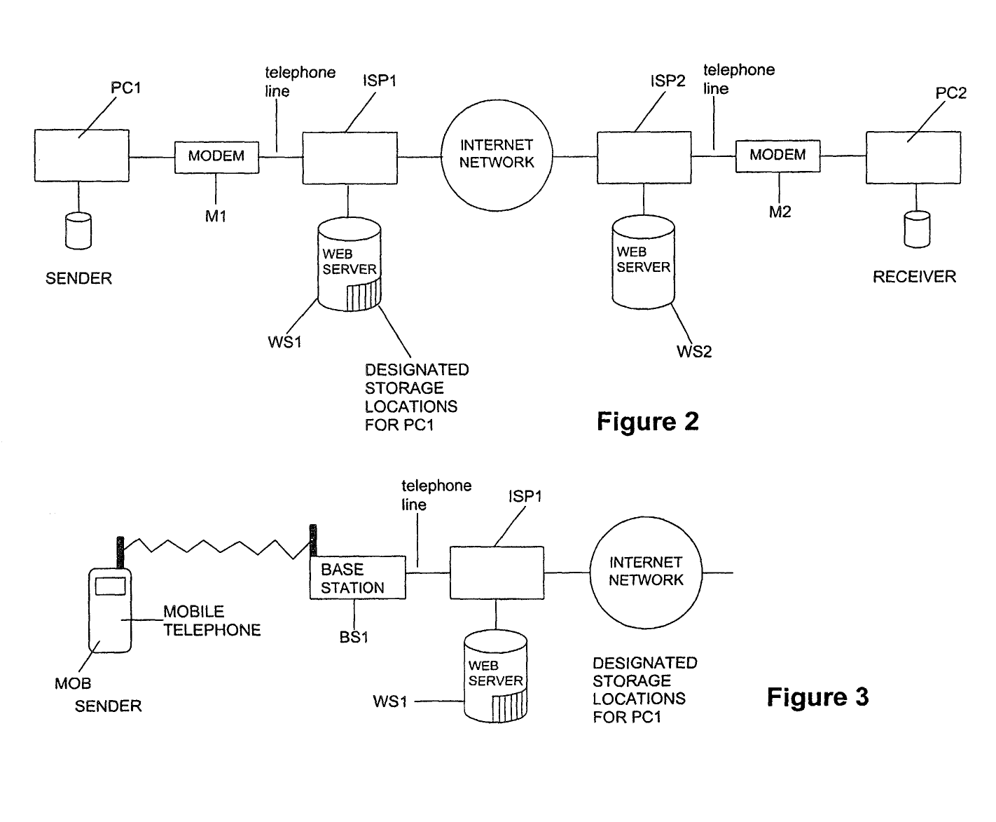

FIG. 2, and in accordance with the invention, in which a mobile telephone is used by the sender of an e-mail, and

FIG. 4 is a schematic similar to FIG. 2 but showing the use of a personal web server.

### DESCRIPTION OF PREFERRED EMBODIMENTS

With reference to FIG. 2, PC1 is a personal computer with which a user desires to send an e-mail message to a recipient address which is the address associated with a personal computer PC2 which is remote from PC1. Internet service providers ISP1 and ISP2 provide links respectively between PC1 and the internet, and PC2 and the internet. ISP1 also provides a web server over which PC1 has certain rights in relation to an allocation of storage sites on the web server.

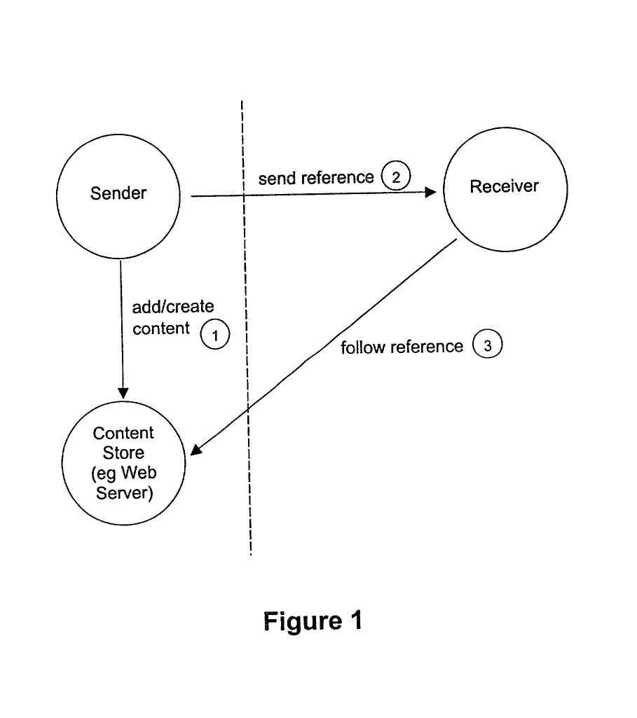

As shown in FIG. 1, when the user of PC1 desires to send an e-mail to the intended recipient at PC2, the composed e-mail message is first transmitted by way of modem M1 to a web server WS1 provided by an internet service provider ISP1. WS1 contains a plurality of storage locations which are available for use by PC1, and a selection of one of these allocated storage locations is selected by software in PC1 performing a random selection procedure amongst the addresses of the allocated storage locations, and the e-mail message is read into that selected location.

As described so far, in principle the data in the chosen storage location is available to anyone having a connection with the internet, but they do not know the address, and moreover they are not aware of how to satisfy an authentication procedure that would allow them access to the data.

Once the e-mail message has been read into the web server WS1 a notification, in the form of a reference, is then sent to PC2, via modem M1, ISP1, an internet connection, ISP2 and modem M2, to inform PC2 that an e-mail message from the named user (or organisation) of PC1 has been stored at the particular storage address of WS1.

When the user of PC2, the intended recipient, checks PC2 to see what emails have been received, and sees that an e-mail has been ‘sent’ by the user of PC1, when the user then attempts to open-up the e-mail the opening-up procedure will cause PC2, by appropriate software, to attempt to access the specific storage location of WS2.

Preferably the attempt to access the specific storage location of WS1 is accompanied by the supply to ISP1 of a suitable proof of identity of the intended recipient of the e-mail, and this proof of identity is checked by ISP1 before permitting PC2 to access the stored e-mail message.

The proof of identity could contain a digitally signed hash of the actual e-mail message, the hash having been included in the reference notification In the circumstances that PC1 incorporates an integral web server then the procedure is different, as follows:

In the flow diagram of FIG. 1, and as just described, the first step in the procedure involves storage of the e-mail message in the selected storage location, and the second step is to notify the recipient computer of the existence of an e-mail. However, there can be an advantage to the user in some circumstances of first notifying the intended recipient of the proposal to provide an e-mail, before the e-mail message has been finalised for sending to the selected storage location.

It will be appreciated that, as far as the recipient computer PC2 is concerned, it has received an e-mail notification at the time at which it receives the notification from PC1.

Even once the reference notification has been transmitted to PC2, the sender is able to amend or replace the initial message stored in the specific storage location.

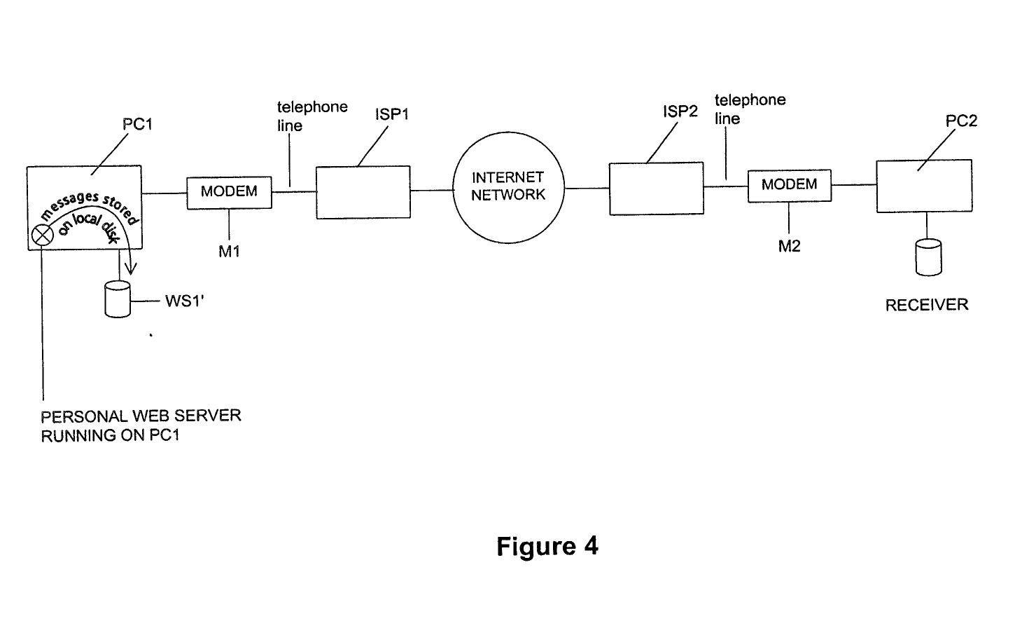

FIG. 3 shows a modification to the system of FIG. 2 in which a mobile telephone MOB is used by the sender to communicate with the internet by way of a base station BS1.

FIG. 4 shows a modification to the system of FIG. 2. Corresponding reference numerals have been applied to corresponding components. The system of FIG. 4 differs from that of FIG. 2 in that the web server WS1′ is a personal web server, such as MICROSOFT™ PWS, running on PC.

It will be appreciated that the foregoing embodiments of the invention can provide the following benefits:i)

i) deletion of an e-mail message sent in error if receiver has not already viewed it,

ii) authentication prior to read,

iii) archive message immediately,

iv) insist on not receiving it because they do not access it,

v) guarantee delete after read/x people have read it.

1. A method of communicating an e-mail a text message over a network from a user terminal to an intended recipient terminal at a remote location, the method comprising the steps of:
(a) the user terminal specifying a confidential message store address of a server (WS1) that is capable of being accessed by the recipient computer via the network;
(b) the user terminal transmitting said e-mail text message to said store address to reside therein;
(c) the user terminal transmitting a notification over the network to the recipient, said notification incorporating said selected store address and an instruction to the intended recipient to communicate with said store address; and
(d) said recipient terminal accessing said store address to retrieve said text message.

2. The method of claim 1 in which step (a) comprises selecting the message store address from a range of possible addresses.

3. The method of claim 1 in which step (c) is performed before step (b).

4. The method of claim 1 in which the user terminal is a personal computer.

5. The method of any one of claims 1 to 3 in which the user terminal is a mobile telephone.

6. The method of claim 4 in which the data store address is an address of a server incorporated into the personal computer.

7. The method of claim 1 in which the message store is a server that is remote from the user terminal.

8. The method of claim 1 comprising the additional step of (e) monitoring the accessing by the recipient terminal of said text message from said message store.

9. The method of claim 8 comprising the additional step of deleting the text message from the message store following accessing of the text message by the recipient terminal.

10. The method of claim 8 comprising the additional step of deleting the text message from the message store following accessing of the message by a predetermined number of recipient terminals.

11. The method of claim I comprising an authentication step which must be successfully completed prior to the recipient terminal being permitted to access the store address, said authentication step comprising an authentication communication between the recipient terminal and the server, the server determining from the identity proffered by the user terminal whether or not to allow access to the message.

12. The method of claim 1 in which the network is the internet.

13. A method of communicating an e-mail text message over a network from a user personal computer to an intended recipient terminal at a remote location, the method comprising the steps of:
(a) the personal computer specifying a confidential message store address of a server (WS1) that is capable of being accessed by the recipient computer via the network;
(b) the personal computer transmitting said e-mail text message to said store address to reside therein;
(c) the personal computer transmitting a notification over the network to the recipient, said notification incorporating said selected store address and an instruction to the intended recipient to communicate with said store address; and
(d) said recipient terminal accessing said store address to retrieve said text message.

14. A method of communicating an e-mail text message over a network from a personal computer, said personal computer comprising a personal web server, to an intended recipient terminal at a remote location, the method comprising the steps of:
(a) the personal computer specifying a confidential message store address of said personal web server that is capable of being accessed by the recipient computer via the network;
(b) the personal computer transmitting said e-mail text message to said store address to reside therein;
(c) the personal computer transmitting a notification over the network to the recipient, said notification incorporating said selected store address and an instruction to the intended recipient to communicate with said store address; and
(d) said recipient terminal accessing said store address to retrieve said text message.

15. A computer program product comprising computer readable program code executable by a user terminal to cause the following steps to be executed by said user terminal in response to a user command to said user terminal to transmit an e-mail text message from said user terminal to a recipient terminal, said steps comprising:
(a) the user terminal specifying a confidential message store address of a server (WS1) that is capable of being accessed by the recipient computer via the network;
(b) the user terminal transmitting said e-mail text message to said store address to reside therein; and
(c) the user terminal transmitting a notification over the network to the recipient, said notification incorporating said selected store address and an instruction to the intended recipient to communicate with said store address.

16. A computer terminal capable of transmitting data over a network to A remote recipient computer, wherein said computer terminal is configured such that on inputting of an instruction to cause an e-mail text message to be transmitted to a recipient computer, the transmitting terminal instead selects a confidential message store address on a server that is capable of being accessed via the network by the recipient computer, the transmitting terminal transmits the text message to that store address, and sends a notification via the network to the recipient computer, the notification providing information that the text message is available to the recipient computer by accessing the particular store address.

17. A computer terminal as claimed in claim 16 comprising a delay timer for delaying the transfer of the text message from the computer terminal to the message store address until a predetermined time has elapsed after the terminal attempted to issue the notification to the recipient computer.

18. A computer terminal as claimed in claim 16 in the form of a personal computer, the server being incorporated into the personal computer.

19. A computer terminal as claimed in claim 18 in which the server is arranged to monitor accessing of the selected message address and to provide a report on such accessing, the report being made available to the user of the terminal.

20. A computer terminal as claimed claim 16 comprising authentication checking means for receiving and checking a proof of identity proffered by a recipient computer prior to allowing the recipient computer to access the text message at the store address.
